(19) United States
(12) Patent Application Publication
(10) Pub. No.: US 2019/0253649 A1
(43) Pub. Date: Aug. 15, 2019

(54) IMAGE PICKUP ELEMENT AND METHOD FOR COMPENSATING IMAGE

(71) Applicant: SAMSUNG ELECTRONICS CO., LTD., Suwon-si (KR)

(72) Inventors: TAKASHI OKAZAKI, YOKOHAMA-SHI (JP); JUNJI SUZUKI, YOKOHAMA-SHI (JP)

(21) Appl. No.: 16/248,563

(22) Filed: Jan. 15, 2019

(30) Foreign Application Priority Data
Feb. 13, 2018 (JP) 2018-023511
Aug. 21, 2018 (KR) 10-2018-0097523

(51) Int. Cl. H04N 5/365; H04N 5/341

(52) U.S. Cl. CPC H04N 5/3658; H04N 5/363; H04N 5/341

(57) ABSTRACT

An image pickup element is configured to remove fixed pattern noise at a fixed density over time. The image pickup element includes an image pickup unit and a compensating unit. The image pickup unit converts light, received by light-receiving elements in unit pixels arranged in a matrix, into an electric charge to output electronic image data. The compensating unit subtracts and removes a noise pattern from the image data, while having a storage unit store the noise pattern of fixed pattern noise of the image data. The compensating unit reads data output and obtained during cutting in a vertical blanking interval of each frame. The compensating unit reads image data and reads the data obtained during cutting of all of the light-receiving elements in an image pickup area from at least one frame among frames listed in time series. The compensating unit averages the data obtained during cutting with the noise pattern, read from the storage unit, to update the noise pattern.

### CROSS-REFERENCE TO RELATED APPLICATION(S)

This U.S. non-provisional patent application claims priority to Japanese Patent Application No. 2018-023511, filed on Feb. 13, 2018 in the Japanese Patent Office, and to Korean Patent Application No. 10-2018-0097523, filed on Aug. 21, 2018 in the Korean Intellectual Property Office, the disclosures of which are incorporated herein by reference in their entirety.

### BACKGROUND

### 1. Technical Field

The present disclosure relates to an image pickup element and a method for compensating an image.

### 2. Description of Related Art

Noise, generated in an image pickup element such as a complementary metal-oxide-semiconductor (CMOS) image sensor, may be random noise and fixed pattern noise (FPN). The random noise may change with time, while the fixed pattern noise may occur constantly over time.

The fixed pattern noise includes pixel fixed pattern noise, vertical fixed pattern noise, horizontal fixed pattern noise, and the like. The pixel fixed pattern noise is noise generated in pixel units. The vertical fixed pattern noise is noise of the vertical stripes generated in column units of an image. The horizontal fixed pattern noise is noise of the horizontal stripes generated in row units of an image. The fixed pattern noise may be significant when gain is mainly increased at a low level of illuminance. Accordingly, fixed pattern noise may be detected best in an image captured in the dark with little light.

A known method for compensating a pixel value output by each pixel by signal processing may include removing vertical fixed pattern noise. First, an image is captured in a dark place without light. Then, a pixel value is averaged for each column of the image. Averaging is continuously performed via various frames, thereby detecting vertical fixed pattern noise. Then, the detected vertical fixed pattern noise is subtracted from the pixel values of the output image data. Therefore, an image from which the vertical fixed pattern noise is removed may be output.

According to the related art, an image needs to be captured in a dark place in order to detect the fixed pattern noise. In a pixel value actually used to obtain image data, light reaches a pixel, so the pixel value actually used to obtain image data may not be used for detection of fixed pattern noise. In other words, fixed pattern noise is best detected in an image captured in a dark place, and image data is best obtained in an image not captured in a dark place.

Moreover, fixed pattern noise may change with temperature or gain. Thus, even when fixed pattern noise is once obtained and compensated during activation, a difference in fixed pattern noise may occur when an image is actually captured. Thus, it may be difficult to accurately remove fixed pattern noise from an image.

In recent years, as the sensitivity of cameras has increased, compensation for fixed pattern noise at a fixed density has been required. As a result, a magnitude of fixed pattern noise to be removed is reduced in some instances compared to the actual magnitude of fixed pattern noise. The fixed pattern noise may be insignificant due to other random noise, a deviation in signal for each pixel, or the like. Thus, a larger number of samples to be averaged may be required to extract fixed pattern noise.

However, the number of pixels of an optical black area may be low, as compared with a magnitude of fixed pattern noise to be detected. Thus, when compensation is performed using optical black, a deviation for each pixel may be significant, so fixed pattern noise may not be stably detected. If the optical black area is increased, fixed pattern noise may be stably detected. However, a size of a device or costs from increasing the optical black area may not be realistic.

An aspect of the present disclosure provides a new and improved image pickup element capable of removing fixed pattern noise at a fixed density over time, and a method for compensating an image.

### SUMMARY

According to an aspect of the present disclosure, an image pickup element includes an image pickup unit, a storage unit, and a compensating unit. The image pickup unit converts light, received by light-receiving elements in unit pixels arranged in a matrix, into an electric charge to output electronic image data. The storage unit stores a noise pattern of fixed pattern noise of the image data. The compensating unit subtracts and removes the noise pattern from the image data. The compensating unit reads data output while a switch connecting one of the light-receiving elements to a read wiring is cut in an invalid interval, different from a valid interval in which image data is output by the image pickup unit. The compensating unit reads the image data and reads data output while the switch connecting each of the light-receiving elements to the read wiring is cut, from each of the light-receiving elements in an image pickup area from at least one frame among frames listed in time series. The compensating unit averages the noise pattern from the storage unit with the data output while the switch connecting each of the light-receiving elements to the read wiring is cut, to update the noise pattern.

According to an aspect of the present disclosure, a method for compensating an image removes fixed pattern noise from electronic image data read by an image pickup unit, in an image pickup element that converts light received by light-receiving elements in unit pixels arranged in a matrix in an image pickup unit into an electric charge, to output electronic image data. The method for compensating the image includes reading data output while a switch connecting each of the light-receiving elements to a read wiring is cut in an invalid interval, different from a valid interval in which image data is output by the image pickup unit. The method also includes updating the noise pattern by reading the image data and reading the data output while the switch connecting each of the light-receiving elements to the read wiring is cut, from each of the light-receiving elements in an image pickup area from at least one frame among frames listed in time series, and averaging a past noise pattern with the data output while the switch connecting each of the light-receiving elements to the read wiring is cut. The method further includes compensating image data by subtracting the noise pattern from the image data read by the image pickup unit, and outputting the compensated image data. The reading data output while the switch connecting each of the light-receiving elements to the read wiring is cut, the updating the noise pattern, the compensating image data, and the outputting the image data are repeatedly performed.

### BRIEF DESCRIPTION OF DRAWINGS

The above and other aspects, features and other advantages of the present disclosure will be more clearly understood from the following detailed description, taken in conjunction with the accompanying drawings, in which:

FIG. 1 is a schematic block diagram illustrating an image pickup element according to an example embodiment;

FIG. 2 is a block diagram illustrating a configuration of a compensating unit according to an example embodiment;

FIG. 3 is an explanation drawing illustrating an example of data output while the switch connecting each of the light-receiving elements to the read wiring is cut, read for each frame, according to an example embodiment;

FIG. 4 is a graph illustrating a change in time of data, read in each row, according to an example embodiment;

FIG. 5 is a block diagram illustrating a configuration of a detecting unit according to an example embodiment;

FIG. 6 is a flow diagram illustrating processing of a detecting unit according to an example embodiment;

FIG. 7 is a block diagram illustrating a configuration of a subtracting unit according to an example embodiment;

FIG. 8 is a flow diagram illustrating processing of a subtracting unit according to an example embodiment;

FIG. 9 is an example of an image before being input to a compensating unit of an image pickup device;

FIG. 10 is an example of an image output by a compensating unit of an image pickup device according to a first example;

FIG. 11 is an example of an image from which a vertical pattern noise is removed using optical black;

FIG. 12 is an explanation drawing illustrating an example of data output while the switch connecting each of the light-receiving elements to the read wiring is cut, read for each frame by an image pickup device according to a second example;

FIG. 13 is an explanation drawing illustrating an example of data output while the switch connecting each of the light-receiving elements to the read wiring is cut, read for each frame by an image pickup device according to a third example; and

FIG. 14 is an explanation drawing illustrating an example of data output while the switch connecting each of the light-receiving elements to the read wiring is cut, read for each frame by an image pickup device according to a fourth example.

### DETAILED DESCRIPTION

With reference to the accompanying drawings in the following, the preferred example embodiments of the present disclosure will be described in detail. In the present specification and drawings, the same reference numerals are given to constituent elements having substantially the same functional configuration, and redundant descriptions are omitted.

### First Example

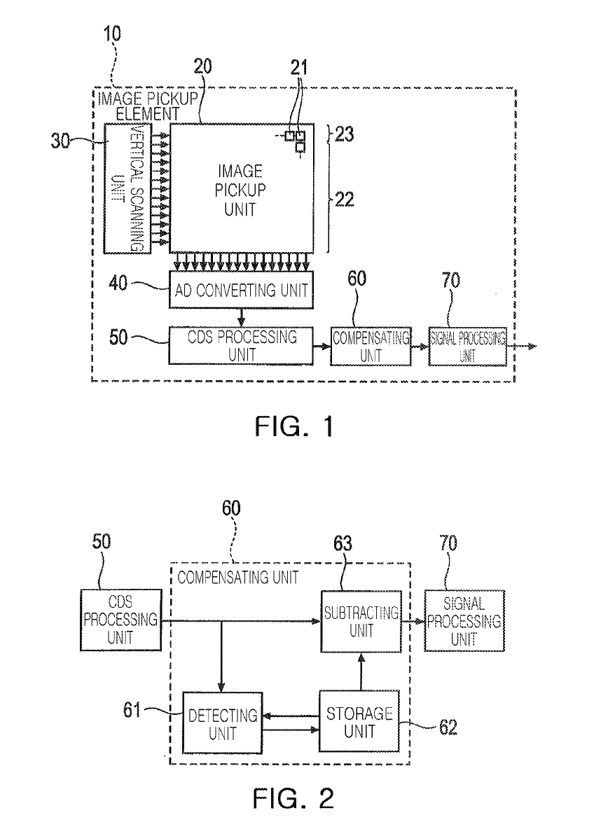

First, referring to FIG. 1, a schematic configuration of an image pickup element 10 according to a first example will be described. The image pickup element 10 according to a first example may be a complementary metal-oxide semiconductor (CMOS) type image sensor. The image pickup element 10 may be applied to a camera system that is configured to continuously capture a frame. The frame is a single still picture configuring a video.

The image pickup element 10 may include an image pickup unit 20, a vertical scanning unit 30, and an AD converting unit 40 (analog to digital converting unit). Moreover, the image pickup element 10 may further include a CDS processing unit 50 (correlated double sampling processing unit), a compensating unit 60, and a signal processing unit 70.

Before proceeding, it should be clear that FIGs. herein including FIG. 1 show and reference circuitry with labels such as “units” or “element(s)”. Such units and elements may include an image pickup element, an image pickup unit, a vertical scanning unit, an AD converting unit, a CDS processing unit, a compensating unit, a signal processing unit, and other elements and units with other labels. As is traditional in the field of the inventive concept(s) described herein, examples may be described and illustrated in terms of blocks such as elements and units which carry out a described function or functions. These blocks, which may be referred to herein as an image pickup element, an image pickup unit, a vertical scanning unit, an AD converting unit, a CDS processing unit, a compensating unit, a signal processing unit, or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the examples may be physically separated into two or more interacting and discrete blocks without departing from the scope of the present disclosure. Likewise, the blocks of the examples may be physically combined into more complex blocks without departing from the scope of the present disclosure.

Additionally, the present application describes a storage unit. A storage unit as the term is used herein is a memory that is tangible and non-transitory. The term “non-transitory” specifically disavows fleeting characteristics such as characteristics of a carrier wave or signal or other forms that exist only transitorily in any place at any time. Memories described herein are tangible storage mediums that can store data and executable instructions, and are non-transitory during the time instructions are stored therein. A memory described herein is an article of manufacture and/or machine component. Memories described herein are computer-readable mediums from which data and executable instructions can be read. Memories as described herein may be line memories, random access memory (RAM), read only memory (ROM), flash memory, electrically programmable read only memory (EPROM), electrically erasable programmable read-only memory (EEPROM), registers, or any other form of storage medium known in the art. Memories may be volatile or non-volatile, secure and/or encrypted, unsecure and/or unencrypted.

The image pickup unit 20 may have multiple instances of a unit pixel 21 arranged in a matrix. Each unit pixel 21 may include a light-receiving element and a transistor circuit to perform photoelectric conversion. Each unit pixel 21 may accumulate a voltage according to an amount of received light. The image pickup unit 20 may include an image pickup area 22 used for image pickup, and an optical black area 23 not used for image pickup. The optical black area 23 is provided adjacent to the image pickup area 22 at a periphery of the image pickup unit 20 away from a cross-sectional center of the image pickup unit 20.

The vertical scanning unit 30 selects a row of the image pickup unit 20 for performing reading of the image pickup unit 20 row-by-row from the top and may have a function of supplying a pulse to the selected row. A unit pixel 21 in the selected row may output the accumulated voltage.

The AD converting unit 40 may have a function of converting an analog voltage received from each row of the image pickup unit 20 into digital data for each column. For example, the analog voltage from each row may be represented as digital data in different columns such as from left to right or right to left. The AD converting unit 40 may supply the converted digital data to the CDS processing unit 50.

The CDS processing unit 50 may have a function of removing reset noise, generated when potential of each unit pixel 21 is reset. The CDS processing unit 50 may perform correlated double sampling. In other words, the CDS processing unit 50 may subtract a voltage value in a reset state from a voltage value in a state in which light is received by each unit pixel 21. Thus, the CDS processing unit 50 may remove reset noise from a digital voltage value, indicating an amount of received light of each unit pixel 21.

The compensating unit 60 may have a function of removing vertical fixed pattern noise. As illustrated in FIG. 2, the compensating unit 60 may include a detecting unit 61, a storage unit 62, and a subtracting unit 63. The compensating unit 60 may read image data and data obtained during cutting, to be described later, from the CDS processing unit 50. The image data, read from the CDS processing unit 50, may be data, from which reset noise of each unit pixel 21 is removed. The data obtained during cutting may be data read from each unit pixel 21 while a switch connecting a light-receiving element to a read wiring of each unit pixel 21 is cut. For example, a switch being “cut” may be taken to mean breaking a connection, disconnecting the switch, turning off the switch, deactivating the switch, changing a position or direction of the switch away from a connection, or any other way of characterizing switching a switch to be off. Vertical fixed pattern noise having a vertical stripe may be provided in the image data and the data obtained during cutting.

The detecting unit 61 may average the data obtained during cutting for each column. The storage unit 62 may be a line memory that stores data in one or more rows. The storage unit 62 may store a noise pattern of the vertical fixed pattern noise. A value in each column may be or correspond to data in a single different row.

The detecting unit 61 may specify the data output while the switch connecting each of the light-receiving elements to the read wiring is cut from the data read from the CDS processing unit 50. Moreover, the detecting unit 61 may read the noise pattern stored in the storage unit 62. The detecting unit 61 may average the data obtained during cutting, obtained from the CDS processing unit 50, with the noise pattern that is read for each column, and may update a noise pattern. The method of averaging is not particularly limited, for example, to a moving averaging method. The data averaged for each column may be stored in the storage unit 62 as a latest noise pattern.

The subtracting unit 63 may subtract the noise pattern, stored in the storage unit 62, from the image data read from the CDS processing unit 50 for each column. The subtracting unit 63 may output the compensated image data to the signal processing unit 70.

The signal processing unit 70 may perform final signal processing of image data, read from the compensating unit 60, before the final image data is provided as output of the image pickup element 10. The signal processing at a rear end may be, for example, contour enhancement processing, white balance processing, or the like.

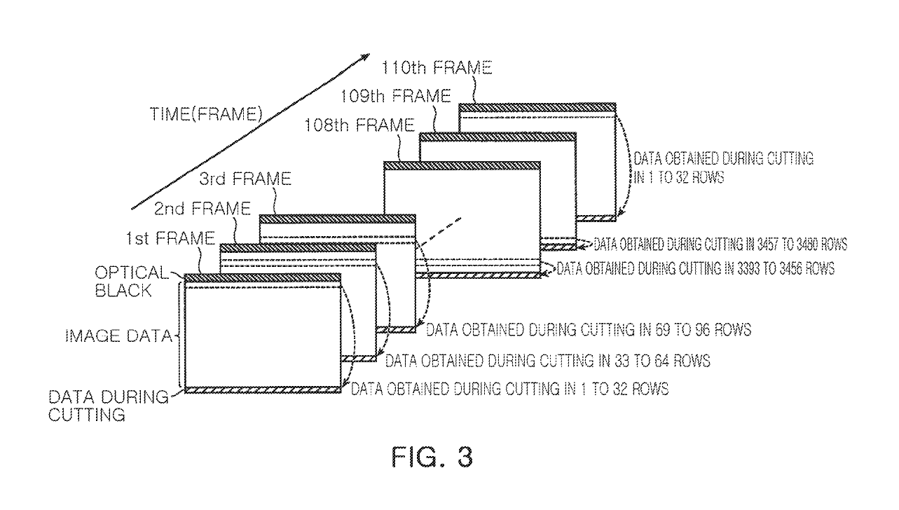

Then, referring to FIG. 3, an example of data input to the compensating unit 60 will be described. The data input to the compensating unit 60 is input as frames listed in time series. Each frame is optical black, image data, and data obtained during cutting. The optical black is output from the optical black area 23. The image data is output from the image pickup area 22. The data output while the switch connecting each of the light-receiving elements to the read wiring is cut is output from a single row or multiple rows in the image pickup area 22. The data output while the switch connecting each of the light-receiving elements to the read wiring is cut is applied in a vertical blanking interval after the image data of each frame. That is, the data obtained during cutting is applied in in a vertical blanking interval after the image data of each frame. The vertical blanking interval may be considered an invalid interval, whereas the image data is output and applied in what may be considered a valid interval. The rows of the image pickup area 22 outputting the data obtained during cutting are changed for each frame.

As an example, FIG. 3 shows that data obtained during cutting of 1 to 32 rows of the image pickup area 22 is applied to a first frame, and data obtained during cutting of 33 to 64 rows is applied to a second frame. As described above, each time a frame is changed, the data that is obtained during cutting, and that is to be applied to the frame, is moved by a single row or multiple rows from the top of the image pickup area 22. Thus, for example, in m frames, data obtained during cutting of all unit pixels 21 in the image pickup area 22 is read. After data obtained during cutting in final n rows of the image pickup area 22 is read, in a next frame, data obtained during cutting is read from a first row or rows, again. Thus, for each frame among m frames, data during cutting of all unit pixels 21 may be read.

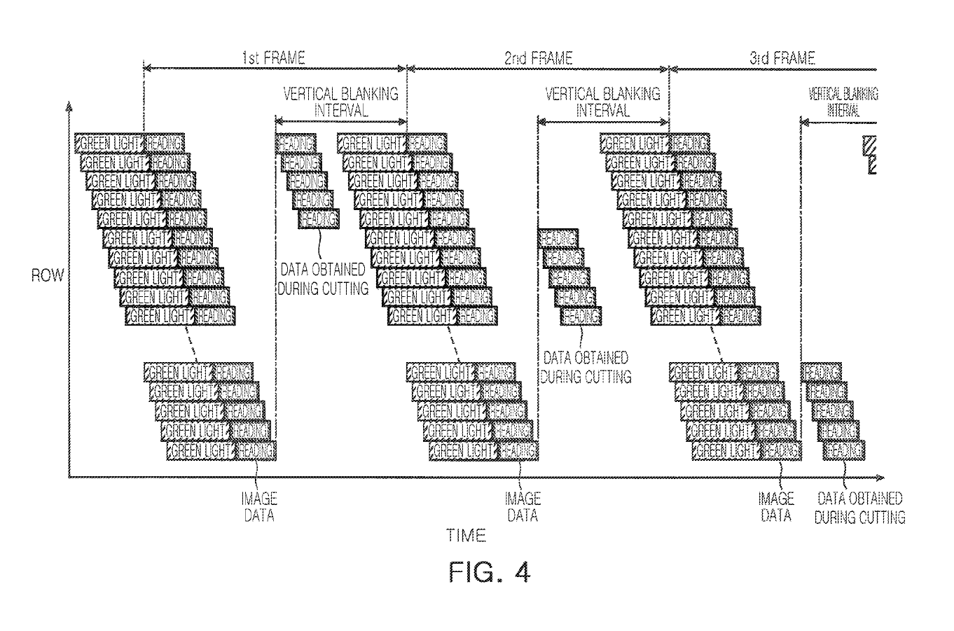

Then, referring to FIG. 4, an example of reading data obtained during cutting in the image pickup element 10 will be described. The number of rows of data obtained during cutting, read for each frame, may be arbitrary, but five rows are illustrated in FIG. 4 for the sake of easier understanding.

The image pickup element 10 may sequentially perform exposure and reading for each row from a first row while shifting the timing, in the image pickup unit 20. The image pickup element 10 reads data obtained during cutting of a specific row in a vertical blanking interval, after reading of image data is performed from a first row to a final row in each frame and before reading of image data begins in a next frame. The data that is obtained during cutting and that is to be read may be specified while moving by a predetermined row from the top, as described above.

As illustrated in FIG. 1, the read image data and data obtained during cutting are converted into a digital signal by the AD converting unit 40, and reset noise is removed therefrom by the CDS processing unit 50. Then, the image data and data obtained during cutting, from which the reset noise is removed, are input to the compensating unit 60. As described above, a noise pattern stored in the storage unit 62 is subtracted from the image data, read by the compensating unit 60, and the image data is then output. The data that is obtained during cutting, and that is read by the compensating unit 60, is averaged with a noise pattern stored in the storage unit 62. A new noise pattern, having been averaged, is stored in the storage unit 62.

Then, the operations described above are repeatedly performed for each frame, so data obtained during cutting within the vertical blanking interval of each frame may be acquired. A row of the data that is obtained during cutting, and that is to be acquired, is moved toward a lower row whenever a frame is changed.

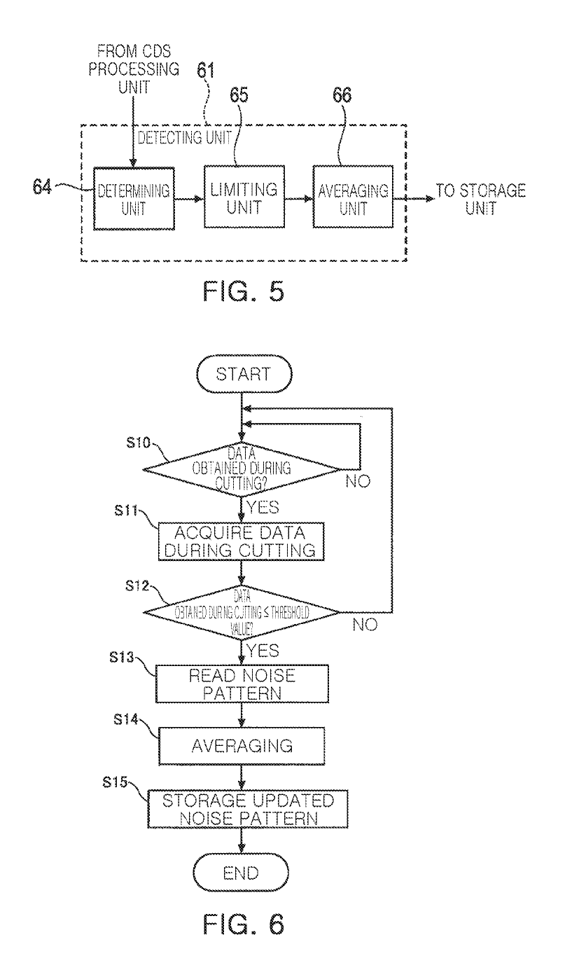

Then, the detecting unit 61 of the compensating unit 60 will be described with respect to block diagrams of FIGS. 2 and 5, as well as a flow diagram of FIG. 6.

The detecting unit 61 determines whether data input by the determining unit 64 is data obtained during cutting (S10). The determining unit 64 receives data obtained during cutting, when it is determined that the data is the data obtained during cutting (S11). The determining unit 64 ignores data, when it is determined that the data is not the data obtained during cutting. Then, the detecting unit 61 determines whether the data obtained during cutting is abnormal data, exceeding a preset threshold value, in a limiting unit 65 (S12). The compensating unit 60 prevents averaging at a rear end (final processing) from being performed in an averaging unit 66, when it is determined that the data obtained during cutting is abnormal data.

The detecting unit 61 reads the noise pattern from the storage unit 62, when the data obtained during cutting is equal to or less than a threshold value (S13). The detecting unit 61 averages the noise pattern, read by the storage unit 62 and the data obtained during cutting, having been newly obtained, for each column, in the averaging unit 66 (S14). Thus, the detecting unit 61 removes an effect of a random noise, and then extracts a noise pattern of fixed pattern noise. Then, a noise pattern of the fixed pattern noise, having been updated, is stored in the storage unit 62 (S15).

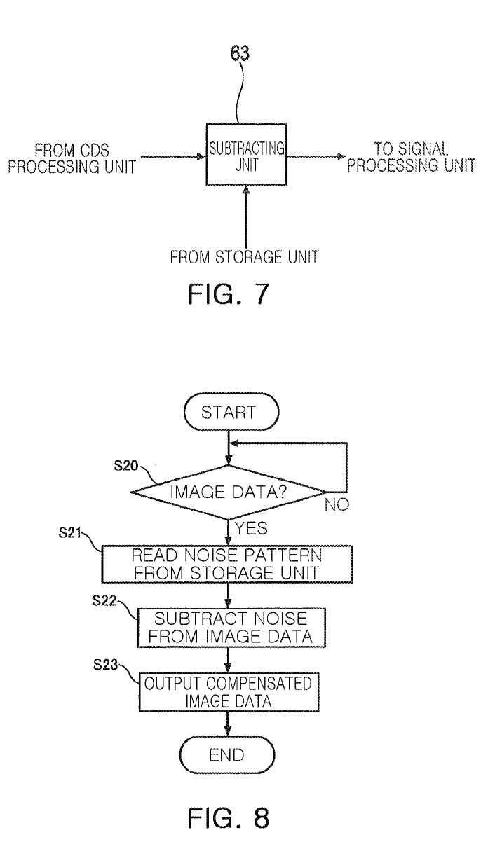

Then, the subtracting unit 63 of the compensating unit 60 will be described with respect to block diagrams of FIGS. 2 and 7, as well as a flow diagram of FIG. 8.

The subtracting unit 63 determines whether input data is image data (S20). When the subtracting unit 63 determines that the data is image data, a noise pattern is read from the storage unit 62 (S21). Then, the subtracting unit 63 subtracts a stored noise pattern corresponding to each column from the input image data (S22). Then, the subtracting unit 63 outputs the image data, from which the fixed pattern noise is removed, to the signal processing unit 70 (S23).

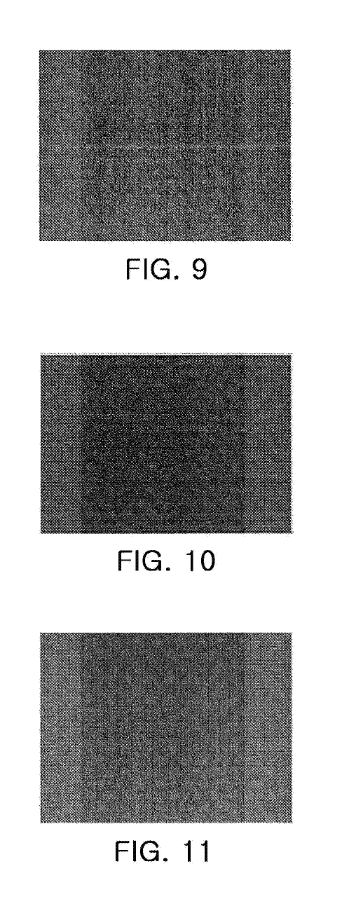

FIG. 9 illustrates an image input to the compensating unit 60, that is, an image before being compensated by a noise pattern. FIG. 10 illustrates an image output from the compensating unit 60, that is, an image after performing compensation by a noise pattern in an example. FIG. 11 illustrates an image from which a noise is removed by a noise pattern of vertical fixed pattern noise obtained using optical black. In the image of FIG. 10, in which compensation is performed by the compensating unit 60, as compared with an image of FIG. 9, in which compensation is not performed yet, a clear image from which a vertical line disappears may be confirmed. In an image of FIG. 11, which is compensated using optical black, a new vertical line appears, so it is confirmed that compensation is not properly performed. The compensation performed by the image pickup element 10 is expected to have a noise improvement effect of about 10 times (20 dB) according to a difference in the number of rows used for compensation in theory, with respect to the compensation using optical black.

As described above, in an image pickup element 10 according to a first example, the image pickup element 10 may include an image pickup unit 20, a compensating unit 60, and a storage unit 62. The image pickup unit 20 converts light received by light-receiving elements of unit pixels 21 arranged in a matrix, into an electric charge to output electronic image data. The compensating unit 60 subtracts and removes a noise pattern from the image data. The storage unit 62 stores the noise pattern of fixed pattern noise of image data. The compensating unit 60 reads data obtained during cutting (e.g., output while a switch connecting a light-receiving element to a read wiring is cut), in a vertical blanking interval (an invalid interval) which is different from a valid interval in which image data is output from the image pickup unit 20 of each frame. The compensating unit 60 reads image data and reads data obtained during cutting of all of the light-receiving elements in an image pickup area 22 from at least one frame among frames listed in time series, and updates the noise pattern by averaging the noise pattern from the storage unit with the data obtained during cutting.

The image pickup element 10, configured as described above, adaptively updates a noise pattern using all of the light-receiving elements in the image pickup area 22 of the image pickup unit 20 during an operation, so fixed pattern noise may be stably removed at a fixed density, regardless of changes in ambient conditions (for example, a change in temperature, and the like), even if time elapses. Moreover, data output during cutting is read in the vertical blanking interval, so the data output during cutting may be obtained from a light-receiving element of the image pickup area 22, without affecting image data. Moreover, the image pickup element 10 removes fixed pattern noise at a fixed density, thereby improving performance at a low level of illumination and improving sensitivity.

In addition, the compensating unit 60 may read data output during cutting from a different row or rows for each single frame. Thus, a row or rows used for calculation of a noise pattern is changed, so a noise pattern of fixed pattern noise may be specified at a fixed density. Thus, the fixed pattern noise may be removed from the output image data at a fixed density.

Moreover, the compensating unit 60 may change a row read from each frame listed in time series from an upper row of the image pickup unit 20. That is, the compensating unit 60 sequentially changes a row, read from each frame listed in time series, from an upper row of the image pickup unit. Thus, the row used for calculation of a noise pattern is moved from the upper row, and the noise pattern may be specified at a fixed density. Thus, the fixed pattern noise may be removed from the output image data at a fixed density.

Moreover, an invalid interval is different from a valid interval. The valid interval is an interval in which image data is output, whereas an invalid interval is a vertical blanking interval. Thus, the compensating unit 60 may adaptively read data output during cutting of a light-receiving element of the image pickup area 22 from the image pickup unit 20, using the vertical blanking interval.

Moreover, the compensating unit 60 determines whether input data is data that was obtained during cutting. When the input data is data that was obtained during cutting, the input data is used for calculation of a noise pattern. When the input data is not data that was obtained during cutting, the input data is excluded from the calculation of a noise pattern. Thus, the data that was obtained during cutting may be effectively determined, and the noise pattern may be updated at a fixed density.

Moreover, the compensating unit 60 determines whether a value of input data is within a range of a preset threshold value. When the value of input data is outside of a range of a threshold value, the input data is excluded from the calculation of a noise pattern. Thus, abnormal data may be effectively determined and the abnormal data may be excluded, and the noise pattern may be updated at a fixed density.

Moreover, in the present disclosure, a method for compensating an image is also provided. In the method for compensating an image, fixed pattern noise is removed from image data in the image pickup element 10 that converts light received by light-receiving elements in unit pixels 21 arranged in a matrix in an image pickup unit 20. The light is converted into an electric charge and output as electronic image data. The method for compensating an image includes reading data obtained during cutting (e.g., output while a switch connecting a light-receiving element to a read wiring is cut), in a vertical blanking interval (an invalid interval) that is different from a valid interval in which image data is output from an image pickup unit 20, updating the noise pattern by reading image data and reading data obtained during cutting of all light-receiving elements of an image pickup area 22 from at least one frame among frames listed in time series, and averaging the data obtained during cutting with a past noise pattern, compensating the image data by subtracting a noise pattern from the image data read from the image pickup unit 20, and outputting the compensated image data. The reading data obtained during cutting, the updating a noise pattern, the compensating image data, and outputting the image data are repeatedly performed.

In the method for compensating an image, configured as described above, a noise pattern is adaptively updated using all of the light-receiving elements in the image pickup area 22 during an operation, so fixed pattern noise may be removed at a fixed density, regardless of changes in ambient conditions (for example, a change in temperature, and the like), even if time elapses. Moreover, data obtained during cutting is read in the vertical blanking interval, so the data obtained during cutting may be obtained from a light-receiving element of the image pickup area 22, without affecting image data.

### Second Example

An image pickup element 10 according to a second example is different from the first example only in that a calibration of a noise pattern is performed during activation.

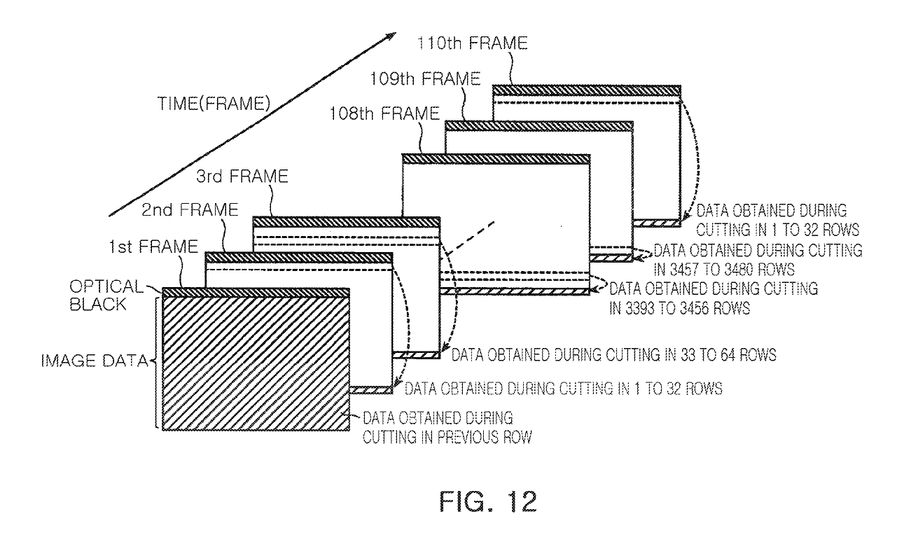

As illustrated in FIG. 12, an image pickup element 10 reads data obtained during cutting of all of the light-receiving elements in an image pickup area 22 to a compensating unit 60, in a first frame after activation. That is, compared to the first example and FIG. 3, the second example and FIG. 12 include and show that a first frame after activation includes data obtained during cutting of all of the light-receiving elements in an image pickup area. The compensating unit 60 averages data obtained during cutting of all of the light-receiving elements during activation for each column to calculate a noise pattern of fixed pattern noise. Then, the compensating unit 60 stores the calculated noise pattern in the storage unit 62.

After a second frame, in a manner similar to the first example, data obtained during cutting is sequentially read from an upper row, in a vertical blanking interval of each frame listed in time series. That is, the compensating unit 60 sequentially changes a row, read from each frame listed in time series, from an upper row of the image pickup unit. The compensating unit 60 subtracts a noise pattern, stored in the storage unit 62, from image data having been read, to be output. The compensating unit 60 averages a noise pattern stored in the storage unit 62 and data obtained during cutting (e.g., data output while the switch connecting each of the light-receiving elements to the read wiring is cut in a collected row), and updates a noise pattern. Thereafter, each time a frame is changed, while a row of data that is obtained from cutting (e.g., data output while the switch connecting each of the light-receiving elements to the read wiring is cut) for the frame is moved, image data is compensated and output, thereby updating a noise pattern.

As described above, a compensating unit 60 according to a second example reads data obtained during cutting of all of the light-receiving elements in an image pickup area 22, from at least one frame after the image pickup element 10 is activated, and calculates a noise pattern from the data obtained during cutting. Thus, a noise pattern at a fixed density may be calculated using all of the light-receiving elements in the image pickup area 22 during activation. Thus, the calculated noise pattern is used as an initial value, and a noise pattern may be adaptively updated at a fixed density in subsequent image pickup. Moreover, the image pickup element 10 obtains data obtained during cutting of all of the light-receiving elements in only at least one frame after activation. Thus, the image pickup element 10 may perform compensation for removing fixed pattern noise at high speed.

### Third Example

An image pickup element 10 according to a third example is different from that according to the first example only in a selection method of a row of data obtained during cutting, read in a vertical blanking interval.

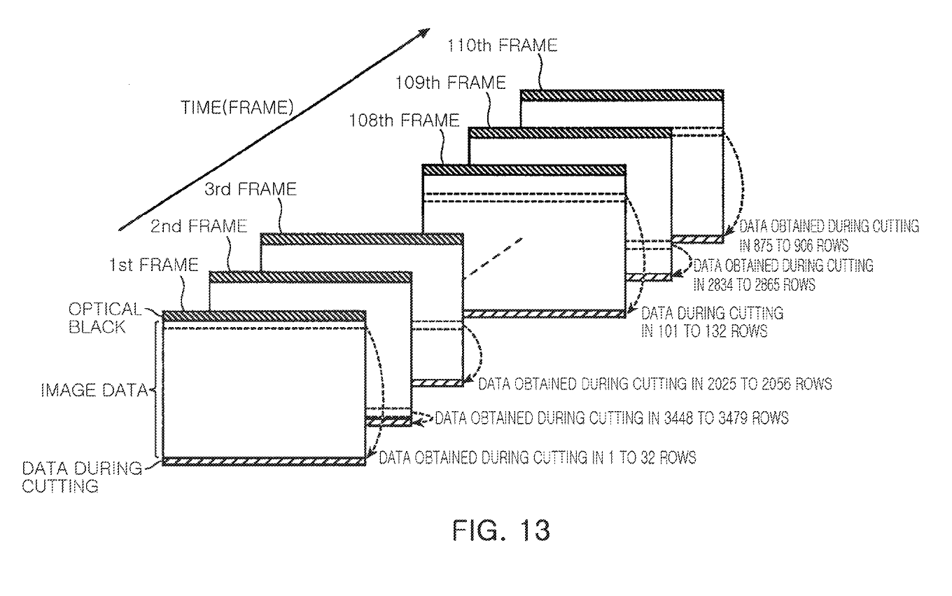

As illustrated in FIG. 13, the image pickup element 10 randomly selects a row of data obtained during cutting, read in a vertical blanking interval of each frame. Of course, the random selection may be pseudo-random, or may be based on a varied and arbitrary input such as a reading of natural data so as not to be predictable. As an example, the image pickup element 10 reads data obtained during cutting in 1 to 32 rows in a vertical blanking interval below the first frame. The image pickup element 10 reads data obtained during cutting in final n rows of the image pickup area 22 in a vertical blanking interval below the second frame. The image pickup element 10 reads data obtained during cutting in 2025 to 2056 rows in a vertical blanking interval below the third frame. Thereafter, the image pickup element 10 may repeatedly perform reading data during cutting in a row or rows, randomly selected, in a vertical blanking interval below each frame. That is, in an embodiment, the compensating unit 60 randomly changes a row or rows, read from each frame listed in time series. The randomness or pseudo-randomness introduced in FIG. 13 results in non-sequential rows or groups of rows being read in vertical blanking intervals for sequential frames.

As described above, the compensating unit 60 according to the third example randomly changes a row read from each frame listed in time series. As the read row is randomly changed, the approximate tendency of the fixed pattern noise in the entirety of a screen may be quickly reflected in image data after compensation. Thus, compensation for removing fixed pattern noise may be performed at high speed.

### Fourth Example

An image pickup element 10 according to a fourth example is different from that according to the first example in that data obtained during cutting is read one by one by skipping one in each frame listed in time series.

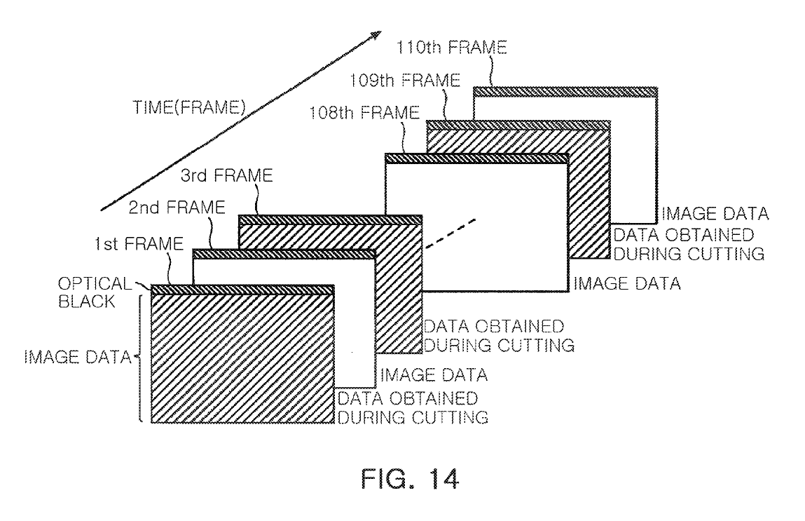

As illustrated in FIG. 14, an image pickup element 10 reads data obtained during cutting of all of the light-receiving elements in an image pickup area 22 to a compensating unit 60, in a first frame. The compensating unit 60 averages data obtained during cutting of all of the light-receiving elements of the first frame, having been read, for each column to calculate a noise pattern of fixed pattern noise. Then, the compensating unit 60 stores the calculated noise pattern in the storage unit 62. The image pickup element 10 may not read image data in the first frame.

The image pickup element 10 may not read data obtained during cutting in the second frame. The image pickup element 10 reads image data of all of the light-receiving elements in an image pickup area 22, in a second frame. The compensating unit 60 subtracts a noise pattern, stored in the storage unit 62, from image data of all unit pixels 21 having been read, to be output.

The image pickup element 10 reads data obtained during cutting of all of the light-receiving elements in an image pickup area 22, in a third frame. The compensating unit 60 averages data obtained during cutting of all of the light-receiving elements of the third frame, having been read, with the noise pattern stored in the storage unit 62 for each column. Then, the compensating unit 60 stores the updated noise pattern in the storage unit 62. The image pickup element 10 may not read image data in the third frame.

The image pickup element 10 may not read data obtained during cutting in the fourth frame. The image pickup element 10 reads image data of all of the light-receiving elements in an image pickup area 22, in the fourth frame. The compensating unit 60 subtracts a noise pattern, stored in the storage unit 62, from image data of all unit pixels 21 having been read, to be output.

Then, in a manner similar to the third frame and the fourth frame, image data and data obtained during cutting are repeatedly read for each frame. Thus, updating of a noise pattern by frames listed alternately, and outputting of image data compensated by a noise pattern are repeatedly performed. A single frame, outputting image data, is provided between two frames, so a frame rate becomes twice.

As described above, a compensating unit 60 according to a fourth example reads data obtained during cutting of all of the light-receiving elements in an image pickup area 22 one by one by skipping one in each frame in time series, and updates a noise pattern using the data during cutting. Thus, a noise pattern at a fixed density may be extracted simultaneously using all of the light-receiving elements in the image pickup area 22. Thus, compensation for removing fixed pattern noise may be performed at a fixed density and at high speed.

While an example embodiment of the present disclosure is described in detail with reference to the accompanying drawings, the disclosure is not limited to this example embodiment. It will be apparent to those skilled in the art that various changes or modifications may be made without departing from the spirit and scope of the inventive concept(s) defined in the appended claims, and these are naturally also within the technical scope of the present disclosure.

For example, the image pickup element 10 may not sequentially select a row of data obtained during cutting read in a vertical blanking interval from the top, and may not randomly select a row thereof. For example, the row of data obtained during cutting, read in a vertical blanking interval by the image pickup element 10, may be selected while being vertically moved in frames listed in time series.

Moreover, an invalid interval for reading data obtained during cutting may be a horizontal blanking interval, provided after each row is read, rather than a vertical blanking interval.

In addition, the image pickup element 10 may use a noise pattern, updated at the end of a previous driving, as an initial value of a noise pattern of fixed pattern noise. Thus, the most recent noise pattern in a stable driving state is used, so compensation at a fixed density may be performed.

As set forth above, according to example embodiments of the present disclosure, a noise pattern is adaptively updated using all of the light-receiving elements in an image pickup area during an operation, thereby removing fixed pattern noise at a fixed density over time.

While example embodiments have been shown and described above, it will be apparent to those skilled in the art that modifications and variations could be made without departing from the scope of the present disclosure, as defined by the appended claims.

What is claimed is:

1. An image pickup element, comprising:
an image pickup unit that converts light, received by light-receiving elements in unit pixels arranged in a matrix, into an electric charge to output electronic image data;
a storage unit that stores a noise pattern of fixed pattern noise of the image data; and
a compensating unit that subtracts and removes the noise pattern from the image data,
wherein the compensating unit reads data obtained during cutting, output while a switch connecting one of the light-receiving elements to a read wiring is cut in an invalid interval, different from a valid interval in which image data is output by the image pickup unit, reads the image data and reads data output during cutting, from each of the light-receiving elements in an image pickup area from at least one frame among frames listed in time series, and averages the noise pattern from the storage unit with the the data output during cutting, to update the noise pattern.

2. The image pickup element of claim 1, wherein the compensating unit reads data obtained during cutting from a different row for each single frame.

3. The image pickup element of claim 1, wherein the compensating unit sequentially changes a row, read from each frame listed in time series, from an upper row of the image pickup unit.

4. The image pickup element of claim 1, wherein the compensating unit randomly changes a row, read from each frame listed in time series.

5. The image pickup element of claim 1, wherein the compensating unit reads the data obtained during cutting of all of the light-receiving elements in the image pickup area, from at least one frame after the image pickup element is activated, and calculates the noise pattern from the data obtained during cutting.

6. The image pickup element of claim 1, wherein the compensating unit reads the data obtained during cutting of all of the light-receiving elements in the image pickup area one by one by skipping one in each frame listed in time series, and updates the noise pattern using the data obtained during cutting.

7. The image pickup element of claim 1, wherein the invalid interval is a vertical blanking interval.

8. The image pickup element of claim 1, wherein the compensating unit determines whether input data is the data obtained during cutting, uses the input data for calculation of the noise pattern when the input data is the data obtained during cutting, and excludes the input data from calculation of the noise pattern when the input data is not the data obtained during cutting.

9. The image pickup element of claim 1, wherein the compensating unit determines whether a value of input data is within a range of a preset threshold value, and excludes the input data from calculation of the noise pattern when the value of input data is out of the range of the threshold value.

10. The image pickup element of claim 2, wherein the compensating unit sequentially changes a row, read from each frame listed in time series, from an upper row of the image pickup unit.

11. The image pickup element of claim 2, wherein the compensating unit randomly changes a row, read from each frame listed in time series.

12. A method for compensating an image by removing fixed pattern noise from electronic image data read by an image pickup unit, in an image pickup element that converts light received by light-receiving elements of unit pixels arranged in a matrix in the image pickup unit into an electric charge, to output the image data, the method for compensating an image comprising:
reading data obtained during cutting, output while a switch connecting each of the light-receiving elements to a read wiring is cut in an invalid interval, different from a valid interval in which image data is output by the image pickup unit;
updating a noise pattern by reading the image data and reading the data obtained during cutting of all of the light-receiving elements in an image pickup area from at least one frame among frames listed in time series, and averaging a past noise pattern with the data obtained during during cutting;
compensating image data by subtracting the noise pattern from the image data read by the image pickup unit; and
outputting the image data which is compensated,
wherein the reading data obtained during cutting, the updating a noise pattern, the compensating the image data, and the outputting the image data are repeatedly performed.

13. The method of claim 12, further comprising:
reading the data obtained during cutting from a different row for each single frame.

14. The method of claim 12, further comprising:
sequentially changing a row, read from each frame listed in time series, from an upper row of an image pickup unit.

15. The method of claim 12, further comprising:
randomly changing a row, read from each frame listed in time series.

16. The method of claim 12, further comprising:
reading the data obtained during cutting of all of the light-receiving elements in an image pickup area, from at least one frame after the image pickup element is activated, and calculating a noise pattern from the data obtained during cutting.

17. The method of claim 12, further comprising:
reading the data obtained during cutting of all of the light-receiving elements in an image pickup area one by one by skipping one in each frame listed in time series, and updating a noise pattern using the data obtained during cutting.

18. The method of claim 12, wherein the invalid interval is a vertical blanking interval.

19. The method of claim 12, further comprising:
determining whether input data is the data obtained during cutting, using the input data for calculation of the noise pattern when the input data is the data obtained during cutting, and excluding the input data from calculation of a noise pattern when the input data is not the data obtained during cutting.

20. The method of claim 12, further comprising:
determining whether a value of input data is within a range of a preset threshold value, and excluding the input data from calculation of a noise pattern when the value of input data is out of the range of the threshold value.
